(19) United States
(12) Patent Application Publication
(10) Pub. No.: US 2015/0150266 A1
(43) Pub. Date: Jun. 4, 2015

(54) PESTICIDE COMPOUNDS, USE THEREOF AND METHOD OF PROTECTION OF PLANTS

(71) Applicant: AGRA GROUP, A.S., Strelske Hostice (CZ)

(72) Inventor: Petr Cigler, Praha 6 (CZ)

(21) Appl. No.: 14/402,638

(22) PCT Filed: May 30, 2013
(86) PCT No.: PCT/CZ2013/000070

§ 371 Date: Nov. 20, 2014

(30) Foreign Application Priority Data
Jun. 1, 2012 (CZ) PV 2012-371

(51) Int. Cl. A01N 59/20

(52) U.S. Cl. CPC A01N 59/20

(57) ABSTRACT

The invention concerns use of compounds of general formula Cu₂SO₃.MSO₃.2H₂O, in which M is Cu, Mn or Fe, for the protection of plants against fungal diseases. A method of protecting plants against fungal diseases and a pesticidal preparation including at least one compound of the general formula is also disclosed.

### FIELD OF ART

The present invention relates to compounds possessing pesticidal activities, to use thereof for prophylaxis and treatment of plant infections caused by fungal pathogens, to a method of protection of plants against fungal pathogens, and to a pesticide preparation containing these compounds.

### BACKGROUND ART

Fungal diseases belong among key pathogens in agricultural production. These pathogens must be controlled in order to prevent further infection of the plants. Apart from causing the decrease of yields, fungi represent a significant health risk for both humans and animals, because they contaminate crops with mycotoxins—products of their own metabolism. The control of fungal diseases therefore has a considerable economic impact.

Various fungicidal products containing organic or inorganic active substances are known in the art and commercially available. The organic substances usually show a high fungicidal activity, however, the application thereof often results in accumulation of toxic residues of xenobiotic organic substances in the environment and in agricultural products entering the food chain. Among the inorganic substances, the low-soluble Cu(II)-compounds are widely used, the fungicidal effect of which is known since 1882 (Bordeaux mixture comprising cupric hydroxide). In general, these compounds show a rather low activity and they must be applied in massive doses (e.g., the recommended dose of cupric oxychloride [CuCl₂.3Cu(OH)₂], commercially available under the trade name Kuprikol 50, is 4 to 5 kg per hectar, which corresponds to 2.0 to 2.5 kg of copper per hectar). High doses of copper compounds burden the soil and result in an undesirable copper accumulation (Kaplan M., J. Plant Nutr. 1999, 22, 237-244).

EP 1471787 discloses a fungicidal preparation allowing to decrease the overall copper dose by using a mixture of cupric hydroxide and at least one other copper compound selected from CuCl₂.3Cu(OH)₂, basic cupric sulphate, Bordeaux mixture and cupric-calcium oxychloride. This mixture allows to increase the effectivity ca 1.4-times, compared to the individual compounds.

The US patent application 2009/136581 discloses fungicide and bactericide preparation comprising cupric hydroxide and water-soluble carboxylic acid derivative as a chelating agent. This mixture allowed to decrease the overall copper dose 1.5-times compared to cupric hydroxide itself or 6.3-times compared to CuCl₂.3Cu(OH)₂ while maintaining the same effect. The decrease of the copper dose according to EP 1471787 and US 2009/136581, however, is still not sufficient.

WO 2010/076038 discloses fungicide preparations based on ternary mixtures of cupric salicylate salt, cupric hydroxide and a component comprising copper and/or calcium hydroxide-chloride or hydroxide-sulphate. The document shows the synergism of these components using the example of Plasmopara viticola mould, but it does not deal with the optimalization of the overall dose of copper per hectar.

There still exists the need for novel pesticide preparations providing copper which would be active at very low application doses and without toxic effects on the plants.

### DISCLOSURE OF THE INVENTION

The aim of the invention is achieved according to the present invention by the provision of novel pesticide preparations comprising double salts of general formula Cu₂SO₃.MSO₃.2H₂O, wherein M is Cu, Mn or Fe, their composition, preparation and use. The synthesis, structure and chemical properties of these compounds are known (Silva L. A., Andrade J. B., J. Braz. Chem. Soc., 2004, 15(2), 170-177), but their fungicidal effects were not yet disclosed.

In particular, the compound Cu₂SO₃.CuSO₃.2H₂O (Chevreul's salt) shows a particularly high fungicidal activity. This double salt contains copper in two oxidation states: Cu²⁺ and Cut Its low solubility is exploited in metallurgical industry for hydrometallurgical separation of copper from solutions containing Cu²⁺ ions (U.S. Pat. No. 4,070,183). The compound can be prepared by several processes, typically by reduction of Cu²⁺ compounds in an aqueous solution using compounds of S⁴⁺ (SO₂, HSO₃⁻ etc.) at an elevated temperature (Calban T. et al., Chem. Eng. Comm 2009, 196, 1018-1029).

The object of the invention is the use of compounds of general formula

Cu₂SO₃.MSO₃.2H₂O (I)

wherein M is Cu, Mn or Fe, for the protection of plants against fungal diseases.

The object of the invention is also a method of protection of plants against fungal diseases, in which at least one compound of the general formula (I) is applied to seeds, plant, fruits or into soil.

Another object of the invention is a pesticidal, in particular fungicidal, preparation for protection of plants, comprising at least one compound of the general formula (I).

The preparation may further contain auxiliary substances such as fillers, surfactants, antioxidants, defoaming agents and other auxiliaries.

Fillers are natural or synthetic organic or inorganic substances which when mixed with the active substance (I) facilitate its application. The filler must be inert and acceptable for use in agriculture. Examples are kaolin, montmorilonite, atapulgite, bentonite, calcite, dolomite, natural or synthetic silicates and aluminosilicates, fertilizers, water or mineral and plant oils and derivatives thereof. Mixtures of these fillers can be used as well. The content of the filler in the mixtures is preferably 1 to 90% w/w, in wettable powders preferably 15 to 80% w/w, in suspension concentrates preferably 5 to 35% w/w.

Surfactants are ionic or non-ionic dispergation agents, soaking agents or emulgators. Examples are salts of naphthalenesulphonic, phenolsulphonic and ligninsulphonic acids, polycondensates of ethylene oxide with fatty acids or amines, substituted phenols (in particular alkylphenols and arylphenols), salts of sulphosuccinic acid esters, salts of alkylbenzenesulphonic acid, taurin derivatives (in particular alkyltaurates), esters of phosphoric acid with polyethoxylated alcohols or phenols, esters of fatty acids with polyols, and derivatives thereof containing sulphate, sulphonate or phosphate moiety. The content of the surfactant in the mixtures is preferably 2 to 60% w/w.

Antioxidants are any compounds acceptable for use in agriculture which are able to stabilize the compounds of the general formula (I) against oxidation. Preferably, compounds containing S⁴⁺ are used, e.g., NaHSO₃, Na₂SO₃, Na₂S₂O₅ or K₂S₂O₅. The content of the antioxidant in the preparation is preferably 0,01 to 10% w/w.

Defoaming agents are any compounds decreasing the foam stability. Preferably, silicone-based compounds are used.

Further auxiliaries are colloid stabilizers, adhesives, binders and rheologic modifiers. Generally, a compound of the general formula (I) can be combined with any liquid or solid additive commonly used for pesticide or fertilizer formulations.

The preparation of the present invention preferably contains 1 to 99% w/w of the compound of general formula (I). When formulated as a wettable powder, it preferably contains 10 to 90% w/w, most preferably 40 to 80% w/w of the compound of general formula (I). When formulated as a suspension concentrate, it preferably contains 1 to 50% w/w, most preferably 5 to 30% w/w of the active compound (I).

In a preferred embodiment, the compound of general formula (I) is Cu₂SO₃.CuSO₃.2H₂O.

The preparations of the invention can be provided as various formulations, suitable for application in agriculture as such or after dilution, such water-dispergable granules or microgranules, wettable powders, water-dispergable tablets, suspensions, suspension concentrates, water-dispergable pastes, emulgable powders, emulgable granules or microgranules, emulgable suspension concentrations, microemulsions, colloid solutions containing nano- or microparticles of the compound of general formula (I). Wettable powders can be filled into soluble wrappers, the use of which prevents undesirable dusting or breathing-in the powder by the user.

For the above-listed applications, the compound of general formula (I) has preferably grain size smaller than 100 μm, more preferably smaller than 75 μm, even more preferably smaller than 50 μm.

The preparation of the invention can contain further substances, such as insecticides, fungicides, bactericides, attractants, acaricides, pheromones and further substances showing biological effects. The presence of these compounds broadens the spectrum of effects of the preparation. Particularly advantageous are combinations with other fungicides. The substances that can be used in such broad-spectrum preparations are, e.g.,
substances capable of inhibiting nucleic acid synthesis, such as benalaxyl, benalaxyl-M, bupirimate, clozylacone, dimethirimol, ethirimol, furalaxyl, hymexazol, mefenoxam, metalaxyl, metalaxyl-M, ofurace, oxadixyl, oxolinic acid;
substances capable of inhibiting mitose and cell division, such as benomyl, carbendazim, diethofencarb, ethaboxam, fuberidazole, pencycuron, thiabendazol, thiophanate-methyl, zoxamid;
substances capable of inhibiting breathing, such as diflumetorim, boscalid, carboxin, fenfuram, flutolanil, furametpyr, furmecyclox, mepronil, oxycarboxin, penthiopyrad, thifluzamid, amisulbrom, azoxystrobin, cyazofamid, dimoxystrobin, enestrobin, famoxadone, fenamidone, fluoxastrobin, kresoxim-methyl, metominostrobin, orysastrobin, picoxystrobin, pyraclostrobin, trifloxystrobin
substances capable of inhibiting oxidative phosphorylation, such as dinocap, fluazinam, meptyldinocap;
substances capable of ATP synthesis inhibition, such as fentin acetate, fentin chlorid, fentin hydroxide, silthiofam;
substances capable of inhibiting aminoacid and protein biosynthesis, such as andoprim, blasticidin-S, cyprodinil, kasugamycin, kasugamycin hydrochlorid hydrate, mepanipyrim, pyrimethanil;
substances capable of inhibiting signal transmission, such as fenpiclonil, fludioxonil, chinoxyfen;
substances capable of inhibiting lipid and membrane component synthesis, such as bifenyl, chlozolinate, edifenphos, etridiazol, iodocarb, iprobenfos, iprodione, isoprothiolan, procymidon, propamocarb, propamocarb hydrochlorid, pyrazophos, tolclofos-methyl, vinclozolin;
substances capable of inhibiting ergosterol biosynthesis, such as aldimorph, azaconazol, bitertanol, bromuconazol, cyproconazol, diclobutrazol, difenoconazol, diniconazol, diniconazol-M, dodemorph, dodemorph acetate, epoxiconazol, etaconazol, fenarimol, fenbuconazol, fenhexamid, fenpropidin, fenpropimorph, fluquinconazol, flurprimidol, flusilazol, flutriafol, furconazol, furconazol-cis, hexaconazol, imazalil, imazalil sulfate, imibenconazol, ipconazol, metconazol, myclobutanil, naftifin, nuarimol, oxpoconazol, paclobutrazol, pefurazoate, penconazol, prochloraz, propiconazol, prothioconazol, pyributicarb, pyrifenox, simeconazol, spiroxamin, tebuconazol, terbinafin, tetraconazol, triadimefon, triadimenol, tridemorph, triflumizole, triforin, triticonazol, uniconazol, viniconazol, voriconazol;
substances capable of inhibiting cell wall synthesis, such as benthiavalicarb, dimethomorph, flumorph, iprovalicarb, mandipropamid, polyoxins, polyoxorim, validamycin A;
substances capable of inhibiting melamine biosynthesis, such as carpropamid, diclocymet, fenoxanil, ftalid, pyroquilon, tricyklazol;
substances capable of inducing resistance towards pathogens and insect pests, such as acibenzolar-S-methyl, probenazol, tiadinil;
substances with a wide range of therapeutic effects, such as Bordeaux misture, captafol, captan, chlorothalonil, copper naphtenane, copper(II) oxide, copper(II) oxychloride, copper-calcium oxychloride, copper(II) hydroxide, copper(II) sulphate, basic copper(II) sulphate, dichlofluanid, dithianon, dodine, dodine free base, ferbam, fluorofolpet, folpet, guazatine, guazatine acetate, iminoktadin, iminoktadin albesilate, iminoktadin triacetate, mancopper, mancozeb, maneb, metiram, zinc metiram, copper(II) bis(8-hydroxyquinolinate), propineb, sulphur and sulphur-containing preparations, such as calcium polysulphide, tolylfluanid, zineb, ziram;
compounds selected from the following list: (2E)-2-(2-{[6-(3-chloro-2-methylphenoxy)-5-fluorpyrimidin-4-yl]oxy}phenyl)-2-(methoxyimino)-N-methylacetamide, (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, 1-(4-chlorophenyl)-2-(1H-1,2,4-triazol-1-yl)cycloheptanol, 1-[(4-methoxyphenoxy)methyl]-2,2-dimethylpropyl-1H-imidazole-1-carboxylate, 1-methyl-N-[2-(1,1,2,2-tetrafluoroethoxyl)phenyl]-3-(trifluoromethyl)-1H-pyrazole-4-carboxamide, 2,3,5,6-tetrachloro-4-(methylsulphonyl)pyridine, 2-butoxy-6-iodo-3-propyl-4H-chromen-4-one, 2-chloro-N-(1,1,3-trimethyl-2,3-dihydro-1H-inden-4-yl)nicotinamide, 2-phenylphenol and salts thereof, 3-(difluoromethyl)-1-methyl-N-[2-(1,1,2,2-tetrafluoroethoxyl)phenyl]-1H-pyrazole-4-carboxamide, 3-(difluoromethyl)-N-[(9R)-9-isopropyl-1,2,3,4-tetrahydro-1,4-methanonaphthalen-5-yl]-1-methyl-1H-pyrazole-4-carboxamide, 3-(difluoromethyl)-N-[(9S)-9-isopropyl-1,2,3,4-tetrahydro-1,4-methanonaphthalen-5-yl]-1-methyl-1H-pyrazole-4-carboxamide, 3-(difluoromethyl)-N-[4′-(3,3-dimethylbut-1-yn-1-yl)biphenyl-2-yl]-1-methyl-1H-pyrazole-4-carboxamide, 3,4,5-trichloropyridine-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-chloro-7-(4-methylpiperidin-1-yl)-6-(2,4,6-trifluorophenyl)[1,2,4]triazolo[1,5-a]pyrimidine, 8-hydroxyquinoline sulphate, benthiazol, bethoxazin, capsimycin, carvone, chinomethionat, cufraneb, cyflufenamid, cymoxanil, dazomet, debacarb, dichlorofen, diclomezine, dicloran, difenzoquat, difenzoquat methylsulfate, diphenylamin, ecomate, ferimzone, flumetover, fluopicolid, fluoroimid, flusulfamid, fosetyl-aluminium, fosetyl-calcium, fosetyl-sodium, hexachlorbenzen, irumamycin, isotianil, methasulfocarb, methyl (2E)-2-{2-[({cyclopropyl[4-methoxyphenyl)imino]methyl}thio)methyl]phenyl}-3-methoxyacrylate, methyl 1-(2,2-dimethyl-2,3-dihydro-1H-inden-1-yl)-1H-imidazole-5-carboxylate, methyl isothiocyanate, metrafenon, mildiomycin, N-(3′,4′-dichloro-5-fluorobiphenyl-2-yl)-3-(difluoromethyl)-1-methyl-1H-pyrazole-4-carboxamide, N-(3-ethyl-3,5,5-trimethylcyclohexyl)-3-(formylamino)-2-hydroxybenzamide, N-(4-chloro-2-nitrophenyl)-N-ethyl-4-methylbenzenesulphonamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloronicotinamide, N-[1-(5-bromo-3-chloropyridin-2-yl)ethyl]-2,4-dichloronicotinamide, N-[1-(5-bromo-3-chloropyridin-2-yl)ethyl]-2-fluoro-4-iodonicotinamide, N-[2-(1,3-dimethylbutyl)phenyl]-5-fluoro-1,3-dimethyl-1H-pyrazol-4-carboxamide, N-{(Z)-[(cyclopropylmethoxy)imino][6-(difluoromethoxy)-2,3-difluorophenyl]methyl}-2-phenylacetamide, N-{2-[1,1′-bi(cyclopropyl)-2-yl]phenyl}-3-(difluoromethyl)-1-methyl-1H-pyrazole-4-carboxamide, N-{2-[3-chloro-5-(trifluoromethyl)pyridin-2-yl]ethyl}-2-(trifluoromethyl)benzamide, natamycine, N-ethyl-N-methyl-N′-{2-methyl-5-(trifluoromethyl)-4-[3-(trimethylsilyl)propoxy]phenyl}imidoformamide, N-ethyl-N-methyl-N′-{2-methyl-5-(difluoromethyl)-4-[3-(trimethylsilyl)propoxy]phenyl}imidoformamide, nickel(II) dimethyldithiocarbamate, nitrothal-isopropyl, O-{1-[(4-methoxyphenoxy)methyl]-2,2-dimethylpropy}1H-imidazole-1-carbothioate, octhilinon, oxamocarb, oxyfenthiin, pentachlorofenol and salts thereof, phosphonic acid and salts thereof, piperalin, propamocarb fosetylate, propanosin-sodium, proquinazid, pyribencarb, pyrrolnitrin, quintozene, S-allyl-5-amino-2-isopropyl-4-(2-methylphenyl)-3-oxo-2,3-dihydro-1H-pyrazole-1-carbothioate, tecloftalam, tecnazene, triazoxid, trichlamid, valiphenal, zarilamid;
compounds with bactericidal effects, such as bronopol, dichlorofen, nitrapyrin, nickel(II) dimethyldithiocarbamate, kasugamycin, octhilinon, furancarboxylic acid, oxytetracyclin, probenazol, streptomycin, tecloftalam, copper(II) sulphate and further compounds and preparations containing copper.

The preparation of the invention can be used for both curative and prophylactic protection of plants against fungal pathogens in such a way that it is applied to the plants, seeds, fruits or into the soil in which the plants are grown. The crops that can be protected by this method include, e.g., cotton plant, flax, grapevine, crops of the family Rosaceae (e.g., apple tree, pear tree, apricot tree, almond tree, peach tree, strawberry plant), Ribesioidae, Juglandaceae, Betulaceae, Anacardiaceae, Fagaceae, Moraceae, Oleaceae, Actinidaceae, Lauraceae, Musaceae, Rubiaceae, Theaceae, Sterculiceae, Rutaceae (e.g., lemon tree, orange tree, grapefruit), Solanaceae (e.g., tomato), Liliaceae, Asteraceae (e.g. lettuce), Umbelliferae, Cruciferae, Chenopodiaceae, Cucurbitaceae, Papilionaceae (e.g., peas), Graminae (e.g., corn, grass or cereals such as wheat, barley, oat, rye or triticale), Asteraceae (e.g., sunflowers), Poaceae (e.g., rice, sorghum), Cucurbitaceae (e.g., cucumber, pumpkin, melon, marrow), Brassicaceae (e.g., cabbage), Cruciferae (e.g., rape plant), Apiaceae (e.g., carrots, parsley, celery), Alliaceae (e.g., onion), Fabacae (e.g., peanut), Papilionaceae (e.g., soybean, lens, peas, beans), Solanaceae (e.g., potatoes, pepper), Chenopodiaceae (e.g., sugar beet, spinach); in general, agricultural, technical and horticultural crops and their genetically modified homologues.

The preparation of the invention can preferably be used for the protection of the cereals of the family Graminae, e.g., wheat, barley, oat, rye or triticale.

The preparation of the invention can be used for prophylaxis or treatment of, e.g., the following diseases caused by the pathogens of the genera:

Alternaria, caused by, e.g., Alternaria solani;
Aspergillus, caused by, e.g., Aspergillus flavus;
Blumeria, caused by, e.g., Blumeria graminis;
Botrytis, caused by, e.g., Botrytis cinerea;
Bremia, caused by, e.g., Bremia lactucae;
Cercospora, caused by, e.g., Cercospora beticola;
Cladosporum, caused by, e.g., Cladosporium cucumerinum;
Claviceps, caused by, e.g., Claviceps purpurea;
Cochliobolus caused by, e.g., Cochliobolus sativus;
Colletotrichum, caused by, e.g., Colletotrichum lindemuthanium;
Corticium, caused by, e.g., Corticium graminearum;
Cycloconium, caused by, e.g., Cycloconium oleaginum;
Diaporthe, caused by, e.g., Diaporthe citri;
Diplodia, caused by, e.g., Diplodia maydis
Elsinoe, caused by, e.g., Elsinoe fawcettii;
Esca, caused by, e.g., Phaemoniella clamydospora;
Eutypa, caused by, e.g., Eutypa lata;
Fusarium, caused by, e.g., Fusarium oxysporum, Fusarium culmorum, Fusarium solani,
Fusarium graminearum, Fusarium verticillioides or Fusarium moniliforme;
Gaeumannomyces, caused by, e.g., Gaeumannomyces graminis;
Gibberella, caused by, e.g., Gibberella zeae nebo Gibberella fujikuroi;
Gloeosporium, caused by, e.g., Gloeosporium laeticolor;
Glomerella, caused by, e.g., Glomerella cingulata;
Guignardia, caused by, e.g., Guignardia bidwelli;
Gymnosporangium, caused by, e.g., Gymnosporangium sabinae;
Helminthosporium, caused by, e.g., Helminthosporium solani;
Hemileia, caused by, e.g., Hemileia vastatrix;
Leptosphaeria, caused by, e.g., Leptosphaeria maculans nebo Leptosphaeria nodorum;
Magnaporthe, caused by, e.g., Magnaporthe grisea;
Microdochium, caused by, e.g., Microdochium nivale;
Monilinia, caused by, e.g., Monilinia taxa;
Monographella, caused by, e.g., Monographella nivalis;
Mycosphaerella, caused by, e.g., Mycosphaerella graminicola, Mycosphaerella
arachidicola or Mycosphaerella fijiensis;
Nectria, caused by, e.g., Nectria galligena;
Ophiostoma, caused by, e.g., Ophiostoma ulmi (Brisman) Nannf.;
Penicillium, caused by, e.g., Penicillium expansum nebo Penicillium brevicompactum;
Peronospora, caused by, e.g., Peronospora pisi nebo P. brassicae;
Phaeosphaeria, caused by, e.g., Phaeosphaeria nodorum;
Phakopsora, caused by, e.g., Phakopsora pachyrhizi nebo Phakopsora meibomiae;
Phoma, caused by, e.g., Phoma beta, Phoma batata nebo Phoma solani;
Phomopsis, caused by, e.g., Phomopsis viticola
Phytophthora, caused by, e.g., Phytophthora infestans nebo Phytophthora cactorum;
Plasmopara, caused by, e.g., Plasmopara viticola;
Podosphaera, caused by, e.g., Podosphaera leucotricha;
Pseudoperonospora, caused by, e.g., Pseudoperonospora humuli nebo Pseudoperonospora cubensis;
Puccinia, caused by, e.g., Puccinia recondita;
Pyrenophora, caused by, e.g., Pyrenophora teres;
Pythium, caused by, e.g., Pythium ultimum;
Ramularia, caused by, e.g., Ramularia collo-cygni;
Rhizoctonia, caused by, e.g., Rhizoctonia solani;
Rhizopus, caused by, e.g., Rhizopus arrhizus nebo Rhizopus stolonifer;
Rhynchosporium, caused by, e.g., Rhynchosporium secalis;
Sclerotinia, caused by, e.g., Sclerotinia sclerotiorum;
Sclerotium, caused by, e.g., Sclerotium rolfsii;
Septoria, caused by, e.g., Septoria apii nebo Septoria lycopercisi;
Sphacelotheca, caused by, e.g., Sphacelotheca reiliana;
Sphaerotheca, caused by, e.g., Sphaerotheca fuliginea;
Tapesia, caused by, e.g., Tapesia acuformis;
Taphrina, caused by, e.g., Taphrina deformans;
Thielaviopsis, caused by, e.g., Thielaviopsis basicola;
Tilletia, caused by, e.g., Tilletia caries;
Typhula, caused by, e.g., Typhula incarnata;
Uncinula, caused by, e.g., Uncinula necator;
Urocystis, caused by, e.g., Urocystis occulta;
Uromyces, caused by, e.g., Uromyces appendiculatus;
Ustilago, caused by, e.g., Ustilago nuda;
Venturia, caused by, e.g., Venturia inaequalis;
Verticilium, caused by, e.g., Verticilium alboatrum.

The preparation can preferably be used for protection against diseases caused by the pathogens of the genus Fusarium.

In a particularly preferred embodiment, the preparation is in the form of suspension concentrate and contains 5 to 30 wt. % of the compound of general formula (I), 5 to 45 wt. % of filler, 2 to 60 wt. % of surfactant, solvent and optionally further auxiliary substances. The solvent is preferably water.

The dose of the compound of general formula (I) at foliar application can be in the range of 10 to 1500 g/ha, preferably 25 to 500 g/ha, more preferably 50 to 250 g/ha.

### EXAMPLES OF CARRYING OUT THE INVENTION

### Example 1

### Preparation of Wettable Powders Containing Compounds of General Formula (I)

Wettable powders A to E were prepared from the following raw materials by thorough mixing, grinding and meshing through a 44 μm mesh.

| | Formulation [wt. %] | | | | |
|---|---|---|---|---|---|
| Raw material | A | B | C | D | E |
| Cu₂SO₃•CuSO₃•2H₂O | 70 | | | 50 | 50 |
| Cu₂SO₃•MnSO₃•2H₂O | | 70 | | 20 | |
| Cu₂SO₃•FeSO₃•2H₂O | | | 70 | | 20 |
| Sodium polynaphthalenesuphfonate | 4 | 4 | 4 | 4 | 4 |
| Kaolin (particle size 1.4 μm) | 26 | 26 | 26 | 26 | 26 |

### Example 2

### Preparation of Suspension Concentrates Comprising Compounds of General Formula (I)

Suspension concentrates F to J were prepared according to the following procedure: kaolin was suspended and hydrated in water. Sodium polynaphthalenesulphonate and compound of general formula (I) were added. The mixture was homogenized.

Stabilized suspension concentrates K to O were prepared according to the following procedure: kaolin was suspended and hydrated in water. Sodium polynaphthalenesulphonate, compound of general formula (I) and sodium hydrogensulphite solution were added. The mixture was homogenized.

| | Formulation [wt. %] | | | | | | | | | |
|---|---|---|---|---|---|---|---|---|---|---|
| Raw material | F | G | H | I | J | K | L | M | N | O |
| Cu₂SO₃•CuSO₃•2H₂O | 15 | | | 10 | 10 | 15 | | | 10 | 10 |
| Cu₂SO₃•MnSO₃•2H₂O | | 15 | | 5 | | | 15 | | 5 | |
| Cu₂SO₃•FeSO₃•2H₂O | | | 15 | | 5 | | | 15 | | 5 |
| Sodium | 3 | 3 | 3 | 3 | 3 | 3 | 3 | 3 | 3 | 3 |
| polynaphthalene- | | | | | | | | | | |
| sulphonate | | | | | | | | | | |
| Kaolin | 35 | 35 | 35 | 35 | 35 | 35 | 35 | 35 | 35 | 35 |
| (particle size 1.4 μm) | | | | | | | | | | |
| Sodium hydrogen- | | | | | | 1 | 1 | 1 | 1 | 1 |
| sulphite, 35% solution | | | | | | | | | | |
| Water | 47 | 47 | 47 | 47 | 47 | 46 | 46 | 46 | 46 | 46 |

### Example 3

### Fungal Mycelium Growth Inhibition Assay

The assay for inhibitory activity of compounds of general formula (I) to radial growth and morphological effects to mycelia was carried out in agar by a multiple dilution method. The compound was diluted to concentrations shown in the Table in potato dextrose agar prepared in accordance with manufacturer's instructions. Petri dishes were filled with the thus prepared agar and aseptically inoculated with a disc of the diameter of 0.4 cm cut from a 7-day agar culture of the respective fungus. Controls were prepared in an analogous manner, using sterile distilled water instead of compound of general formula (I). The Petri dishes were incubated for 7 days at 21° C. and then the diameter of the colonies was measured. The percentage of inhibition of radial growth of the respective fungus was calculated according to the following equation: inhibition [%]=(DC-DT)/DC×100, wherein DC is the diameter of control colony and DT is the diameter of the colony grown on the agar containing the respective amount of compound of general formula (I). Standard deviation corresponds to averages from 3 replications.

The results are shown in Tables 1 and 2. The compound Cu₂SO₃.CuSO₃.2H₂O inhibited the growth of all tested mycelia (Table 1). Individual micelia have shown a variation in the sensitivity to the compound and concentration dependency on the fungicide dose was observed. The tested mycelia exhibited significant morphological changes, such as sparse or atypical growth (Table 2) which is beneficial for fungicidal use.

TABLE 1
Percentage of radial growth inhibition

| | Cu₂SO₃•CuSO₃•2H₂O [mg/mL agar] | | |
|---|---|---|---|
| Mycelium | 0.3 | 0.4 | 0.5 |
| Fusarium oxysporum | 6.72 ± 0.05% ¹⁾ | 59.70 ± 0.16% ¹⁾ | 97.76 ± 0.00% |
| Fusarium verticillioides | −2.81 ± 0.00% ²⁾ | 19.10 ± 0.16% ²⁾ | 30.90 ± 0.00% ²⁾ |
| Penicillium brevicompactum | 77.78 ± 0.09% | 95.24 ± 0.00% | 100.00 ± 0.00% |
| Penicillium expansum | 98.37 ± 0.05% | 96.75 ± 0.05% | 100.00 ± 0.00% |
| Aspergillus flavus | 97.67 ± 0.05% | 98.84 ± 0.05% | 100.00 ± 0.00% |
| Aspergillus fumigatus | 100.00 ± 0.00% | 100.00 ± 0.00% | 100.00 ± 0.00% |

¹⁾ sparse mycelium
²⁾ sparse yeast-like growth of the mycelium

TABLE 2
Morphological changes of mycelia

| | Cu₂SO₃•MnSO₃•2H₂O | | Cu₂SO₃•FeSO₃•2H₂O | |
|---|---|---|---|---|
| | [mg/mL agar] | | [mg/mL agar] | |
| Mycelium | 0.5 | 0.9 | 0.5 | 0.9 |
| Fusarium oxysporum | sparse yeast- | sparse yeast- | sparse yeast- | sparse yeast- |
| | like growth of | like growth of | like growth of | like growth of |
| | the mycelium | the mycelium | the mycelium | the mycelium |
| Aspergillus flavus | inhibition of | atypical growth, | changes in | changes in |
| | sporulation, | irregular and | pigmentation | pigmentation |
| | changes in | very sparse | around the | around the |
| | pigmentation | mycelium | colony | colony |

### Example 4

### Field Trial with Crops

In 2010 and 2011, field trials using Triticum aestivum L. and Hordeum vulgare L. were performed. The experimental field was chosen in a warm region suitable for beet cultivation, with sufficient precipitation, soil type was brown earth. The plants were treated using a common agrotechnology, with the exception of the application of fungicidal protection. Instead, the compound Cu₂SO₃.CuSO₃.2H₂O was applied in the form of foliar spraying of wettable powder A prepared according to Example 1, in the dose according to Table 3, in the growth phase BBCH 62 (flowering), when the cereals are typically treated against the Fusarium mould infection of the ear. The broadscale commercial fungicidal preparation Horizon 250 EW (Bayer) containing tebuconazol as the active substance was used as a control, in the dose recommended by the manufacturer (Table 3). Water was used as the negative control.

At the end of the vegetative season, the crops were harvested and the yield was determined. For both crops, positive effect on the yield was observed, the yield increased by 3.2 to 10.1% (see Table 3). No phytotoxic effects were observed, neither occurrence of fusarioses or other fungal diseases. In comparison with the recommended dose of the commercial fungicide Horizon 250 EW, the yield was similar or higher. The total dose of copper per Nectar corresponding to the lower application dose of Cu₂SO₃.CuSO₃.2H₂O (125 g/ha), which was fully sufficient to ensure the protective fungicidal effect, is 61 g/ha, that is 30 to 40 times less than for the usual dose of preparations containing CuCl₂.3Cu(OH)_{2.}

In 2011, a high concentration of Cu₂SO₃.CuSO₃.2H₂O (625 g/ha) was tested for both crops. No phytotoxic effects were observed even at this dose.

TABLE 3

| | | Dose of | Horizon | | |
|---|---|---|---|---|---|
| | | Cu₂SO₃•CuSO₃•2H₂O | 250 EW | Yield | % of the |
| Crop | Year | [g/ha] | [ml/ha] | [t/ha] | control |
| Triticum | 2010 | 125 | — | 7.34 | 104.7 |
| aestivum | | — | 1000 | 7.00 | 100.0 |
| | | — | — | 7.01 | 100.0 |
| | 2011 | 125 | — | 8.45 | 108.1 |
| | | 625 | — | 8.60 | 110.1 |
| | | — | 1000 | 8.08 | 103.4 |
| | | — | — | 7.81 | 100.0 |
| Hordeum | 2011 | 125 | — | 8.65 | 103.2 |
| vulgare | | 625 | — | 8.73 | 104.2 |
| | | — | 1000 | 8.73 | 104.2 |
| | | — | — | 8.38 | 100.0 |

1. Use of compounds of general formula (I)
Cu₂SO₃.MSO₃.2H₂O (I)
wherein M is Cu, Mn or Fe,
for protection of plants against fungal diseases.

2. Use according to claim 1, wherein the compound of general formula (I) is Cu₂SO₃.CuSO₃.2H₂O.

3. A method of protecting plants against fungal diseases, characterized in that at least one compound of general formula (I)
Cu₂SO₃.MSO₃.2H₂O (I)
wherein M is Cu, Mn or Fe
is applied to seeds, plant, fruits or into soil.

4. The method according to claim 3, wherein the compound of general formula (I) is applied using foliar application in the amount in the range of 10 to 1500 g/ha, preferably 25 to 500 g/ha, more preferably 50 to 250 g/ha.

5. The method according to claim 3, wherein the compound of general formula (I) is Cu₂SO₃.CuSO₃.2H₂O.

6. Pesticidal, in particular fungicidal, preparation for protection of plants, characterized in that it contains at least one compound of general formula (I)
Cu₂SO₃.MSO₃.2H₂O (I)
wherein M is Cu, Mn or Fe,
preferably in the amount of 1 to 99 wt. %.

7. The preparation according to claim 6, further containing auxiliary substances selected from the group comprising fillers, surfactants, antioxidants, defoamers and further auxiliaries.

8. The preparation according to claim 6, wherein the compound of general formula (I) is Cu₂SO₃.CuSO₃.2H₂O.

9. The preparation according to claim 6, wherein the compound of general formula (I) has a particle size smaller than 100 μm, preferably smaller than 75 μm, more preferably smaller than 50 μm.

10. The preparation according to claim 6, which further comprises at least one substance selected from the group comprising insecticides, fungicides, bactericides, attractants, akaricides, pheromones and further biologically active substances.

11. The preparation according to claim 6, which is in the form of suspension concentrate and contains 5 to 30 wt. % of the compound of general formula (I), 5 to 45 wt. % of filler, 2 to 60 wt. % of surfactant, solvent and optionally further auxiliary substances.
